(19) United States
(12) Patent Application Publication
(10) Pub. No.: US 2021/0125436 A1
(43) Pub. Date: Apr. 29, 2021

(54) REMOTE CONTROL FOR A VEHICLE WINDOW

(71) Applicant: Gerald Pena, Albuquerque, NM (US)

(72) Inventor: Gerald Pena, Albuquerque, NM (US)

(21) Appl. No.: 16/665,324

(22) Filed: Oct. 28, 2019

(51) Int. Cl. G07C 9/00; B60R 25/01

(52) U.S. Cl. CPC G07C 9/00309; G07C 9/00182; G07C 2009/00222; G07C 2009/00984; B60R 25/01

(57) ABSTRACT

An illustrated view of an exemplary key fobs for remotely opening and closing of a vehicle's window(s) and other activities is presented. The key fob is useful for allowing a driver or other person to remotely open and close a vehicle's window without having access an interior of the vehicle. Thus, the vehicle may be further secured after the driver or other person has left and locked the vehicle by closing the windows. Further, prior to entering the vehicle to start and drive the vehicle, the key fob is useful in remotely opening the window for such a condition as to reduce the temperature inside of the vehicle prior to starting the vehicle, thus reducing use of air conditioning to lower the inside vehicle temperature.

### FIELD OF THE INVENTION

This invention relates to vehicles. More particularly, it relates to devices to key systems for vehicles.

### BACKGROUND

A keyless entry system is an electronic lock that controls access to a building or vehicle without using a traditional mechanical key. The term keyless entry system originally meant a lock controlled by a keypad located at or near the driver's door, which required entering a predetermined (or self-programmed) numeric code. Such systems now have a hidden touch-activated keypad and are still available on certain Ford and Lincoln models.

The term remote keyless system (RKS), also called keyless entry or remote central locking, refers to a lock that uses an electronic remote control as a key which is activated by a handheld device or automatically by proximity.

Widely used in automobiles, an RKS performs the functions of a standard car key without physical contact. When within a few yards of the car, pressing a button on the remote can lock or unlock the doors, and may perform other functions. A remote keyless system can include both a remote keyless entry system (RKE), which unlocks the doors, and a remote keyless ignition system (RKI), which starts the engine.

Some cars have a proximity system that is triggered if a transponder car key is within a certain distance of the car and is sometimes called hands-free or advanced key.

One of the earliest systems was found on the 1993 Chevrolet Corvette (called the Passive Keyless Entry System) and in Mercedes-Benz vehicles from 1998.

Today, this system is commonly found on a variety of vehicles, and although the exact method of operation differs between makes and models, their operation is generally similar: a vehicle can be unlocked without the driver needing to physically push a button on the key fob to lock or unlock the car and is also able to start or stop the ignition without physically having to insert the key and turning the ignition. Instead, the vehicle senses that the key (which may be located in the user's pocket, purse, etc.) is approaching the vehicle.

A simpler version of the smart key system is the engine immobilizer, involving a security key system embedded into most modern vehicle's keys. A small chip rests on the vehicle's key or under the plastic key cover. When any key is inserted into the ignition, the ignition is coded. The key sends its security code to the ignition, which also has its own security code, and if the security codes match, the vehicle will start when the key is turned. However, if the key codes do NOT match, the vehicle will NOT start when the key is turned.

Some security keys can be programmed by the user, though most of these keys have to be programmed by a dealership or locksmith via a computer. It was not possible to copy these keys at a hardware store or auto parts store, but nowadays it is.

While unlocking or locking a car remotely is beneficial to many, these remote systems fall short when it comes to other comforts desired by drivers. Often times, car windows are left “rolled” down when a driver has locked doors of the vehicle. To close the window, the driver unlocks the vehicle and has to enter to actuate the window control. Other times, the driver may want to roll the windows down to allow for air circulation on a hot day to bring the inside temperature of the vehicle down prior to entering the vehicle to start the engine and then over-utilizing the air conditioning.

In light of the foregoing, there is a need for a remote window device to control the opening and closing of windows in a vehicle. Other advantages of the present application are described within the application.

### BRIEF DESCRIPTION OF THE DRAWINGS

FIG. 1 an illustrated view of an exemplary key fob.

FIG. 2 is an illustrated first embodiment of an exemplary window remote fob.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

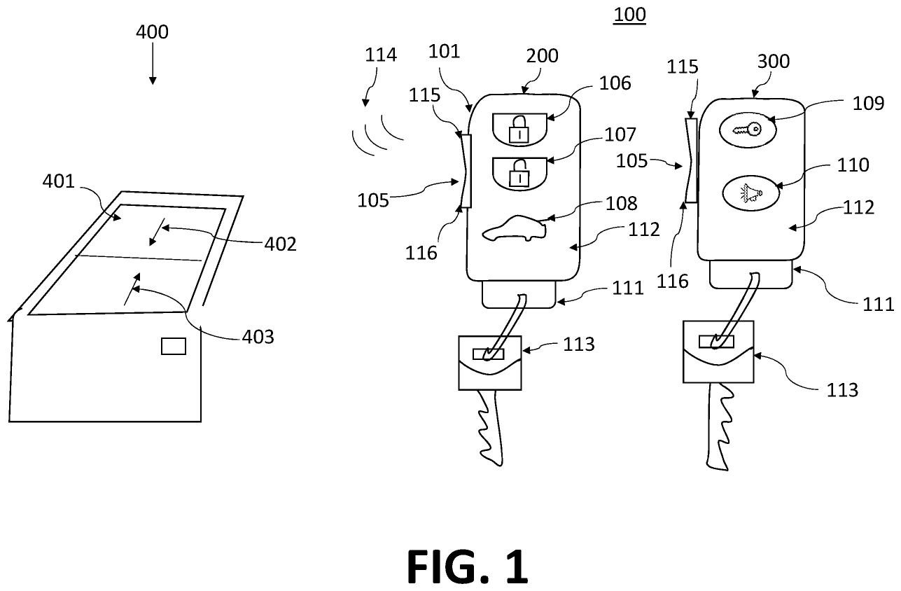

Referring to FIG. 1, an illustrated view of an exemplary first key fob 100 or alternative second key fob 200 for remotely opening and closing of a vehicle's window(s) is presented. The key fob 100 is useful for allowing a driver or other person to remotely open and close a vehicle's window without having access an interior of the vehicle. Thus, the vehicle may be further secured after the driver or other person has left and locked the vehicle by closing the windows. Further, prior to entering the vehicle to start and drive the vehicle, the key fob 100 is useful in remotely opening the window for such a condition as to reduce the temperature inside of the vehicle prior to starting the vehicle, thus reducing use of air conditioning to lower the inside vehicle temperature.

The key fob 100 is preferably three and one-fourth (3.25) inches in height, however other heights are hereby contemplated, including, but not limited to, three (3) inches, four (4) inches, etc. The key fob 100 is preferably one and three-fourth (1.75) inches in width, however other widths are hereby contemplated, including, but not limited to, one and one-half (1.5) inches, two (2) inches, etc. The key fob 100 is preferably three-fourth (0.75) inch in length, however other lengths are hereby contemplated, including, but not limited to, one-half (0.5) inch, one (1) inch, etc. The key fob 100 is preferably made of a plastic material, however other materials are hereby contemplated, including, but not limited to, aluminum, steel, poly-vinyl chloride (PVC), etc.

A car 400 has a plurality of widows 401. The plurality of windows 401 are preferably open/close windows. The windows 401 move in a first direction 402 when the windows 401 are being closed. The windows 401 move in a second direction 403 when the windows 401 are being opened.

Both the key fob 100 and an alternative version of a key fob 200 have a front 112, plurality of sides 101, a window switch 105, a key ring 111 and a key 113.

The front 200 of the key fob 200 has a plurality of first buttons 106, 107, 108. When any of the first buttons 106, 107, 108 are pressed and released, the key fob 100 sends a signal 114 to the vehicle to direct an action.

A first of the first button 106 is symbolized by a lock where the lock is closed. Therefore, the person would lock the vehicle by pressing and releasing the first of the first buttons 106.

A second of the first buttons 107 is symbolized by a lock where the lock is decoupled. Therefore, the person would unlock the vehicle by pressing and releasing the second of the first buttons 107.

A third of the first buttons 108 is symbolized by a trunk of a vehicle being in an open condition. Therefore, the person would remotely open the trunk of the vehicle by pressing and releasing the third of the first buttons 108.

The alternative key fob 200 has a plurality of second buttons 109, 110. When any of the second buttons 109, 110 are pressed and released, the alternative key fob 200 sends a signal 114 to the vehicle to direct an action.

A first of the second buttons 109 has a symbol of a key. Therefore, the person would lock and/or unlock the vehicle by pressing and releasing the first of the second buttons 109.

The second of the second buttons 110 has a symbol of a horn. Therefore, the person could alert for help by pressing and releasing the second of the second buttons 110.

The following description describes actions for both the key fob 100 and the alternative key fob 200. The window switch 105 has a first end 115 and a second end 116. The window switch 105 is coupled on one of the sides 101 of the key fob 100 and the alternative key fob 200.

The window switch 105 controls an upward 403 and downward 402 direction of the windows 401 remotely. The window switch 105 is preferably a toggle switch, however other types of switches are hereby contemplated, including, but not limited to, buttons, lever, etc.

When the first end 115 of the window switch 105 is pressed and held, the key fob 100 and/or the alternative key fob 200 sends a signal 114 to the vehicle 400 to move the window 401 to an upward 403 direction. When the first end 115 of the window switch 105 is released, the key fob 100 and/or the alternative key fob 200 sends a signal 114 to the vehicle 400 to stop the movement of the window 401.

When the second end 116 of the window switch 105 is pressed and held, the key fob 100 and/or the alternative key fob 200 sends a signal 114 to the vehicle 400 to move the window 401 to a downward 402 direction. When the second end 116 of the window switch 105 is released, the key fob 100 and/or the alternative key fob 200 sends a signal 114 to the vehicle 400 to stop the movement of the window 401.

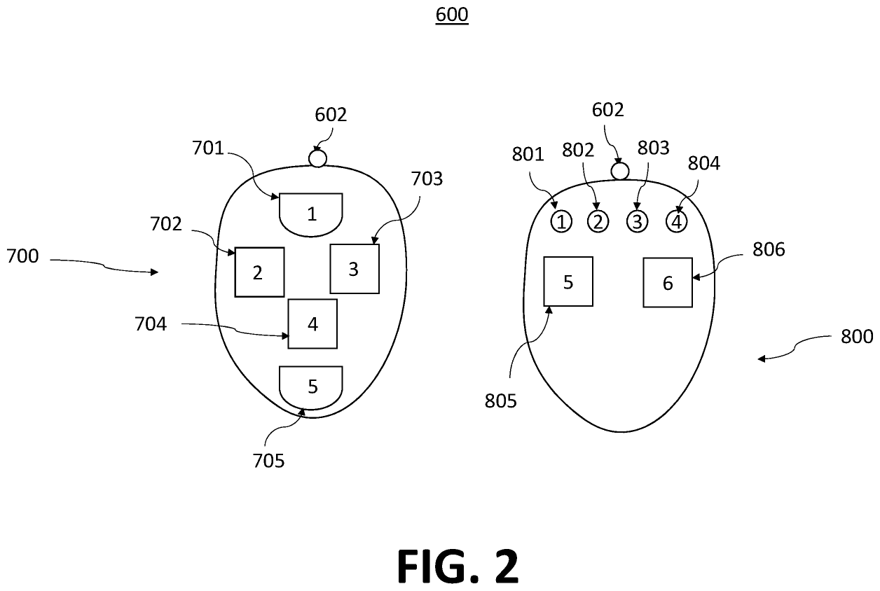

Moving now to FIG. 2, an illustrated view of a second alternative key fob 600 for remotely controlling the a vehicle is presented.

The second alternative key fob 600 is preferably an egg shape, however other shapes are hereby contemplated, including, but not limited to, rectangular, square, oval, etc.

The second alternative key fob 600 has a front 700, a back 800 and a key ring 602. The front 700 has a first button 701, a second button 702, a third button 703, a fourth button 704 and a fifth button 705.

When the first button 701 is pressed and released and the vehicle 400 of FIG. 1 is in an off state, a signal 114 of FIG. 1 is sent to the vehicle 400 of FIG. 1 to start the vehicle 400. When the vehicle 400 is in an idle running state and the first button 701 is pressed and released, a signal 114 of FIG. 1 is sent to the vehicle 400 of FIG. 1 to turn the vehicle 400 off.

When the second button 702 is pressed and released a signal 114 of FIG. 1 is sent to the vehicle 400 of FIG. 1 to lock a door of the vehicle 400.

When the third button 703 is pressed and released a signal 114 of FIG. 1 is sent to the vehicle 400 of FIG. 1 to lock a door of the vehicle 400.

When the fourth button 704 is pressed and released a signal 114 of FIG. 1 is sent to the vehicle 400 of FIG. 1 to unlock a tailgate (not shown) of the vehicle 400.

When the fifth button 705 is pressed and released a signal 114 of FIG. 1 is sent to the vehicle 400 of FIG. 1 to actuate a horn (not shown) of the vehicle 400 to alert that an event has occurred that requires help.

The back 800 has a first button 801, a second button 802, a third button 803, a fourth button 804, a fifth button 805 and a sixth button 806.

When the first button 801 is pressed and released, a first of the windows 401 of FIG. 1 is moved in an upward 403 or downward 402 direction dependent on the current state of a position of the first of the windows 401. A signal 114 is sent to the vehicle 400 to actuate the window 401 in the determined direction.

When the second button 802 is pressed and released, a second of the windows 401 of FIG. 1 is moved in an upward 403 or downward 402 direction dependent on the current state of a position of the second of the windows 401. A signal 114 is sent to the vehicle 400 to actuate the window 401 in the determined direction.

When the third button 803 is pressed and released, a third of the windows 401 of FIG. 1 is moved in an upward 403 or downward 402 direction dependent on the current state of a position of the first of the windows 401. A signal 114 is sent to the vehicle 400 to actuate the window 401 in the determined direction.

When the fourth button 804 is pressed and released, a fourth of the windows 401 of FIG. 1 is moved in an upward 403 or downward 402 direction dependent on the current state of a position of the first of the windows 401. A signal 114 is sent to the vehicle 400 to actuate the window 401 in the determined direction.

When the fifth button 805 is pressed and released, all of the windows 401 of FIG. 1 are moved in a downward 402 direction thus opening all windows 401. A signal 114 is sent to the vehicle 400 to actuate the opening of the windows 401.

When the sixth button 806 is pressed and released, all of the windows 401 of FIG. 1 are moved in an upward 403 direction thus closing all windows 401. A signal 114 is sent to the vehicle 400 to actuate the closing of the windows 401.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An improved key fob for raising and lowering windows of a car remotely, the key fob consisting of:
a front, the front having a plurality of first buttons;
a back, the back having a plurality of second buttons, wherein the second buttons actuate a window of a vehicle to be moved in an upward or a downward direction; and
a wireless signal, wherein the wireless signal conveys a command to the vehicle to move the window in the upward or the downward direction.

2. The key fob of claim 1, wherein the key fob being an egg shape.

3. The key fob of claim 1, wherein the key fob determining the current condition of the window and determining the direction to command the vehicle to move the window.

4. The key fob of claim 3, wherein when the window is in an open condition, the key fob sends a signal to command the window to move the window in the downward direction.

5. The key fob of claim 3, wherein when the window is in an closed condition, the key fob sends a signal to command the window to move the window in the upward direction.

6. The key fob of claim 1, wherein each of the buttons being on a back of the key fob.

7. The key fob of claim 6, wherein each of the button being configured to control a different window.

8. An improved key fob for opening and closing of windows on a vehicle, the key fob consisting of:
a front, the front having a plurality of buttons, wherein the buttons being for operation of a lock, a tailgate and an alert;
a window switch, the window switch coupled to a side of the key fob, wherein the window switch has a first end and a second end; and
wherein when the first end of the window switch is pressed, a signal being sent to a vehicle to move a window in an upward direction, and wherein when the second end of the window switch being depressed, a signal being sent to the vehicle to move the window in a downward direction.

9. The key fob of claim 8, wherein when the first end of the switch being released, the key fob configured to send a signal to the vehicle to stop movement of the window in the upward direction.

10. The key fob of claim 8, wherein when the second end of the switch being released, the key fob configured to send a signal to the vehicle to stop movement of the window in the downward direction.

11. The key fob of claim 9, wherein the key fob being a rectangular shape.

12. The key fob of claim 9, wherein the key fob having a height being three and one-quarter (3.25) inches.

13. The key fob of claim 9, wherein the key fob having a width being one and three-fourths (1.75) inches.

14. The key fob of claim 9, wherein the key fob having a length being three-fourth (0.75) inch.

15. The key fob of claim 9, wherein the key fob being made of a plastic material.

16. The key fob of claim 9, wherein the key fob further comprising a key ring.

17. An improved key fob for raising and lowering windows of a car remotely, the key fob consisting of:
a front, the front having a plurality of first buttons;
a back, the back having a plurality of second buttons, wherein the second buttons actuate a window of a vehicle to be moved in an upward or a downward direction; and
a wireless signal, wherein the wireless signal conveys a command to the vehicle to move the window in the upward or the downward direction, wherein the key fob being an egg shape, wherein the key fob determining the current condition of the window and determining the direction to command the vehicle to move the window, wherein when the window is in an open condition, the key fob sends a signal to command the window to move the window in the downward direction, wherein when the window is in an closed condition, the key fob sends a signal to command the window to move the window in the upward direction, and wherein each of the first buttons and each of the second buttons being configured to control a different window.

18. An improved key fob for opening and closing of windows on a vehicle, the key fob consisting of:
a front, the front having a plurality of buttons, wherein the buttons being for operation of a lock, a tailgate and an alert;
a window switch, the window switch coupled to a side of the key fob, wherein the window switch has a first end and a second end; and
wherein when the first end of the window switch is pressed, a signal being sent to a vehicle to move a window in an upward direction, and wherein when the second end of the window switch being depressed, a signal being sent to the vehicle to move the window in a downward direction, wherein when the first end of the switch being released, the key fob configured to send a signal to the vehicle to stop movement of the window in the upward direction, wherein when the second end of the switch being released, the key fob configured to send a signal to the vehicle to stop movement of the window in the downward direction, wherein the key fob being a rectangular shape, wherein the key fob having a height being three and one-quarter (3.25) inches, wherein the key fob having a width being one and three-fourths (1.75) inches, wherein the key fob having a length being three-fourth (0.75) inch, wherein the key fob being made of a plastic material, and wherein the key fob further comprising a key ring.
